(19) United States
(12) Patent Application Publication
(10) Pub. No.: US 2009/0164234 A1
(43) Pub. Date: Jun. 25, 2009

(54) LIVESTOCK TRACKING SYSTEM AND METHOD

(76) Inventors: Steven C. Sinn, Tremont, IL (US); James Pyle, Harrodsburg, KY (US); Dennis R. Strickland, New Albany, IN (US); Stanley E. Curtis, Urbana, IL (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/359,504

(22) Filed: Jan. 26, 2009

Related U.S. Application Data
(63) Continuation-in-part of application No. 11/337,731, filed on Jan. 23, 2006.

(51) Int. Cl. G06Q 10/00; A01K 29/00

(52) U.S. Cl. 705/1; 119/843; 119/845

(57) ABSTRACT

A livestock tracking system includes the collection of animal data upon loading of the livestock for transport and the collection of similar data upon unloading, thereby monitoring and tracking same. Livestock is transported from a grouped plurality to individual animals capable of being weighed and then put into transport containers. Each transport container is readily identifiable throughout the process such that upon the unloading of the livestock the information pertaining to the livestock within each container can be compared to data collected upon loading and therefore traced. While the most important data is weight, other measurements may be utilized. A method incorporating this system is also disclosed.

### CROSS-REFERENCE TO RELATED APPLICATIONS

This application claims benefit as a continuation-in-part of application Ser. No. 11/337,731 entitled Livestock Unloading System And Method, filed Jan. 23, 2006.

### BACKGROUND OF THE INVENTION

The present invention relates generally to a system for handling livestock and more particularly to a system, means, device or apparatus to affect the efficient handling of livestock in the unloading of same from a transport vehicle to a farm site or processing plant.

It will be understood and appreciated that as the foregoing description of the present invention may be explained as it pertains to the handling of poultry, this description in no way shall be indicative of the limiting of “livestock” thereto.

Commercial poultry, such as turkeys, chickens, guineas, peafowl, ostriches, ducks, geese, swans and pigeons, have been one of man's main staples of protein throughout history. For centuries poultry was raised and processed on the farm and locally delivered to those who desired such fresh poultry. But as the population migrated to towns and cities, delivery of fresh poultry became increasingly difficult while the demand for processed poultry increased dramatically. In response to this need, fresh processed poultry now had to be transported to the markets located in these cities.

The poultry was customarily gathered manually at poultry houses, boxed or crated with numerous birds per crate, manually loaded aboard an open truck or van, and transported. The problems created by such a procedure were both numerous and significant. The manual handling of the poultry not only created a materially high cost involved in raising the poultry and preparing them for market, but it also created certain physical dangers to both the poultry as well as the workmen.

For example, during hand catching and subsequent handling of poultry, some birds are bruised, injured, or even killed due to a violent reaction of the birds or the unintentional rough handling by the workmen. Additionally, fowl inevitably beat their wings in an effort to escape upon capture, this would frequently result in a bird striking the handler with sufficient force to cause physical injury.

As technology was developed for the processing and safe storage of poultry, small processing plants developed and the manual loading and unloading of crates or coops began to improve. One of the first significant improvements, particularly in the turkey industry, was to create coops or crates which were permanently attached to a trailer or truck bed. These trucks contain large numbers of individual coops attached on the truck body. The coops having doors opening outward and being arranged in horizontal rows and vertical tiers. These coops or compartments typically having a permanent middle portion partition, and as such require loading from both sides of the truck. Not only is this time consuming, but loading from both sides also requires the trailer to turn around with all of its weight on one side thus causing an unsafe situation to driver, livestock, machinery and trailer.

The usual method of loading the poultry was to catch the animals individually and then lift and carry them to the coops while using makeshift platforms to reach the higher coops or to hand the birds to other workmen who are clinging to or standing on supports attached to the sides of the truck. The adult male turkey may weigh in excess of forty pounds, thus, any mishandling thereof causes a high incident of injuries to workers and animals alike, not to mention the considerable time requirements needed to accomplish the loading/unloading of a complete truck. The past thirty years have seen various conveyor belt apparatus designs to convey the poultry to the different heights of the vertical tier of coops. However, at the exit end of the conveyor belt, personnel still manually stuffed turkeys into compartments or coops. Thus, while such apparatus eliminated the laborious task of lifting animals to the different heights of coops in the vertical tier, the arduous task of stuffing the live poultry continued.

In light of preceding problems, there has been an effort in the art to develop a method of loading poultry for transport with a minimal amount of manual labor. For example, U.S. Pat. No. 5,902,089, issued May 11, 1999 describes a poultry loading apparatus for transporting poultry from a confinement area such as a poultry house to a transport vehicle to allow transport of poultry from farm-to-farm or from farm-to-processing plant. This is accomplished through the use of a base and a sectional mainframe defining a transport conveyance system. A section of the mainframe is pivotably attached to another section which is pivotably attached to the base. The apparatus further utilizes a control system for its overall leveling and pivotal height adjustments, as well as the extending/retracting capabilities of its conveyance.

Such a conveyance system certainly provides for an apparatus and system for loading poultry for transport that minimizes labor and costs while maximizing efficiency. However, when the fully loaded vehicle stops at its desired location, it must be unloaded. Although this conveyance apparatus is certainly capable of such unloading, it may be difficult to maneuver this apparatus within the typically less spacious area of a processing plant. In any event, the unloading process during the past two generations has not changed. The animals are manually grabbed and pulled out of the crates or coops and inverted on a shackle. Consequently, the animals are under high stress and typically react violently, thereby causing possible injury to themselves and/or the workers/employees. Thus, there exists a need for a poultry unloading apparatus and system that reduces labor costs and damaged product while increasing safety and efficiency.

Today, the poultry business is a multi-billion dollar industry. Large companies dominate the production, slaughter and marketing of products. Since poultry companies are now fewer in number, they therefore demand large quantities of animals daily for processing. In fact, enormous numbers of poultry are transferred daily from production facilities to the slaughter plant or to different production facilities en route to the slaughter plant.

With the advance of science and particularly the art of genetics the animals are becoming larger earlier in life. In fact, the average weight of a male turkey (for example) may exceed fifty pounds within the next five years. This requires a high demand for automation by the processors, and fundamental changes are now occurring as the production and processing consolidates. There will be more focus on creating, managing and tracking supply chains from the farm to the retail shelf that can elevate quality, consistency and demand responsiveness to previously unforeseen levels. At the same time, there is growing evidence that retailers (and ultimately consumers) are becoming increasingly proactive about the processes that generate the meat they are purchasing. More specifically, while all consumers should be concerned with food safety, some consumers have become increasingly proactive with respect to the welfare of the animals they are consuming.

In view of the aforementioned needs and the shortcomings of the prior art, it is therefore an object of the present invention to provide a system that overcomes the deficiencies of the current practices whereby an apparatus and system is provided for unloading livestock for transport with a minimum amount of labor and with maximum efficiency at a minimum cost.

It is another object of the present invention to provide a livestock unloading system which maximizes efficiency and decreases damage to the animals during processing. It is another object of the present invention to provide a livestock unloading system which minimizes labor costs by reducing the number of employees as well as the turnover rate of employees.

It is yet another object of the present invention to provide a livestock unloading system whereby the manual and perhaps rough handling of the livestock is eliminated thereby improving overall animal quality by reducing animal stress and minimizing any damages sustained to the livestock. This reduction of stress decreases fecal contamination which in turn increases food safety.

Still another object of the present invention is to provide a user friendly livestock unloading apparatus that may be operated effectively by very few personnel.

Another object of the present invention is to provide an answer to the animal welfare conscious public regarding the handling of livestock.

Still another object of the present invention is to provide an unloading system that integrates tracking and/or data collection systems for the coop modules, trailers, transport vehicles, coop modules, coop containers and individual livestock.

Yet another object of the present invention is to provide a livestock tracking system and method that identifies livestock and collects data thereon such that the journey of the livestock from farm to consumer is transparent.

These and other objects, features and advantages of the present invention will be clearly understood through a consideration of the following detailed description.

### SUMMARY OF THE INVENTION

According to the present invention there is provided a livestock data collecting system including a plurality of successive conveyors for receiving livestock. Each conveyor having an associated variable speed such that the group of livestock is eventually thinned out and individual livestock are separated by gapped spaces to enable individual data collection.

A system for tracking livestock from farm to consumer is further provided wherein a first set of individual livestock data from uniquely identified containers is stored. A second set of data is collected upon unloading of the container and is compared against the first set to provide reports on the livestock.

A method for tracking livestock from farm to the consumer is also provided. The method includes the steps of loading a group of livestock, separating the group into individuals, collecting data on the individuals, loading the individuals into uniquely identifiable containers, transporting the containers, unloading the containers and collecting data. The comparison of data is then used to generate reports on the livestock.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 is a field loading plan view of a livestock loading system including the loading apparatus and transport vehicle.

FIG. 2 is a perspective view of a transport vehicle in accordance with the principles of the present invention.

FIG. 3 is a rear view of the transport vehicle of FIG. 2.

FIG. 4 is a perspective view of a module of the transport vehicle in FIG. 2.

FIG. 5 is another perspective view of the module of FIG. 4.

FIG. 6 is a side view showing the partition of a coop in the module of the transport vehicle of FIG. 2.

FIG. 7 is a front view of the partition of FIG. 6.

FIG. 8 is a perspective view of a livestock unloading system including a lifting device for a livestock storage module in accordance with the principles of the present invention.

FIG. 9 is a perspective view of the lifting device of FIG. 8.

FIG. 10 is another perspective view of the lifting device of FIG. 8.

FIG. 11 is a side view of the module securing mechanism of the lifting device of FIG. 8.

FIG. 12 is a perspective view of an indicator of the lifting device of FIG. 8.

FIG. 13 is a perspective view of an indicator of the lifting device of FIG. 8.

FIG. 14 is a perspective view of a livestock unloading system including a hoist for positioning a livestock storage module in proximity to an unloader in accordance with the principles of the present invention.

FIG. 15 is a flow diagram or value stream map incorporating the principles of the present invention.

FIG. 16 is a top plan view of the livestock data collecting system incorporating the principles of the present invention during loading of the livestock.

FIG. 17 is an enlarged view of the data collection portions of FIG. 16.

FIG. 18 is an operator screen layout of the loading controller of FIG. 16.

FIG. 19 is a top plan view of a livestock container of FIG. 16 during the unloading process.

FIG. 20 is a top plan view of the livestock tracking system incorporating the principles of the present invention during unloading of the livestock.

### DESCRIPTION OF THE PREFERRED EMBODIMENTS

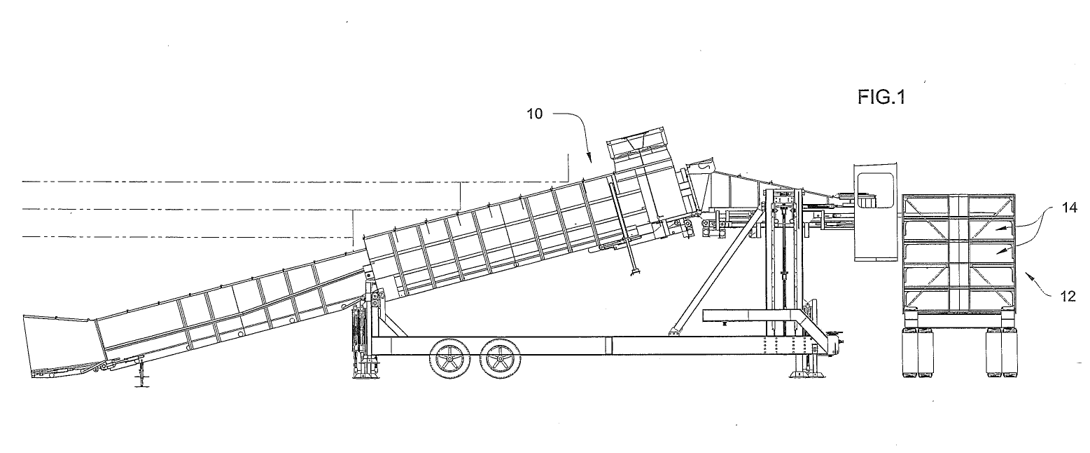

The present invention provides for a system of unloading livestock from a transport vehicle to a farm site or processing plant. As the livestock first require to be loaded upon the vehicle, FIG. 1 illustrates a livestock loading system much like the one disclosed in applicant's recently allowed U.S. patent application Ser. No. 10/044,675, and applicant's issued U.S. Pat. No. 6,447,234, both incorporated herein by reference. The system is shown in its operable state and includes a loading apparatus 10 perpendicular to a transport vehicle 12 having numerous rows of poultry (for example) coops 14. During loading, turkeys (for example) are telescoped by a plastic, steel or rubber conveyor belt into enlarged coops and gently placed on the coop floor. Once the loading process is complete, the transport vehicle 12 departs to eventually arrive at an unloading destination such as another farm or a processing plant.

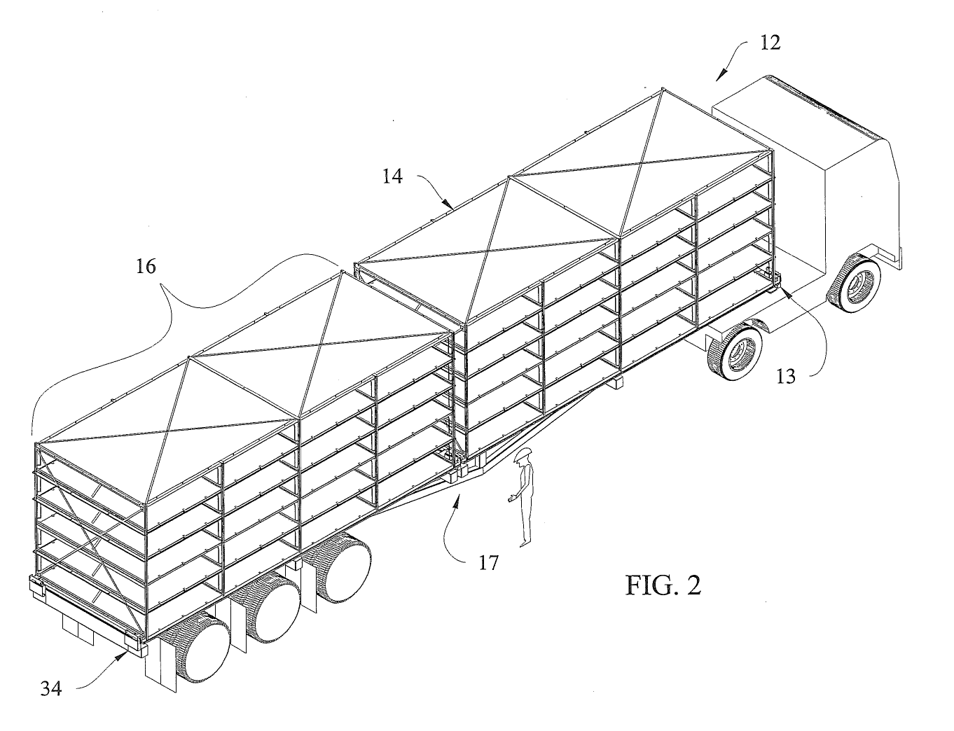

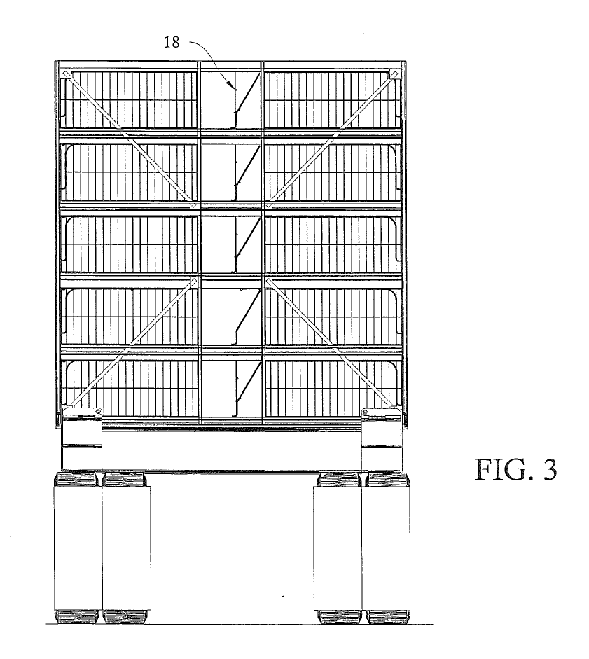

The present invention includes, among other things, a uniquely designed transport vehicle. FIGS. 2 and 3 generally illustrate the advantages of this transport vehicle design. In particular, FIG. 2 depicts a perspective view of the transport vehicle or trailer 12 showing how the transport units or coops 14, sometimes referred to as “racks” in the art, are arranged on the bed of the truck. The truck or trailer may be of conventional design or of a customized design. In this particular embodiment, there are 20 coops 14 per coop module 16. Removable panels (not shown) may further be included and stowed underneath the trailer at 17. FIG. 3 shows a partition 18 of the coops. This partition 18 is operable via a linkage with an associated coop door 22.

Each coop module 16 is secured on the coop trailer 12 via attachment members 13, which will be discussed in further detail below. The coop module 16 is secured onto the trailer in a semi-secure manner to allow the module to move slightly during transport. This movement helps to deter stress cracks on the module frame.

A standard coop trailer typically includes one hundred forty four coops per trailer, with each coop having a volume of about 16 cubic feet. This standard trailer requires the loading of one side of the trailer and turning the trailer around to load the opposite side. As such, the manual unloading process for turkeys entails personnel on both sides of the coop trailer physically grabbing/pulling and inverting the turkey to position its legs into a shackle. By contrast, the present system includes a coop trailer 12 with coops 14 having a volume of about 64 cubic feet. The swinging partition 18 of this trailer 12 allows the extension of the primary indexes of the unloading apparatus through the length of the coop (width of the transport vehicle), thus allowing the trailer to be completely unloaded and loaded from one side. This primary index extension arrangement is described in further detail in co-pending U.S. patent application Ser. No. 10/044,675. With fewer and larger coops, loading/unloading speeds can match processing plants line speed; and biosecurity and cleaning of coop modules are easier and require less time.

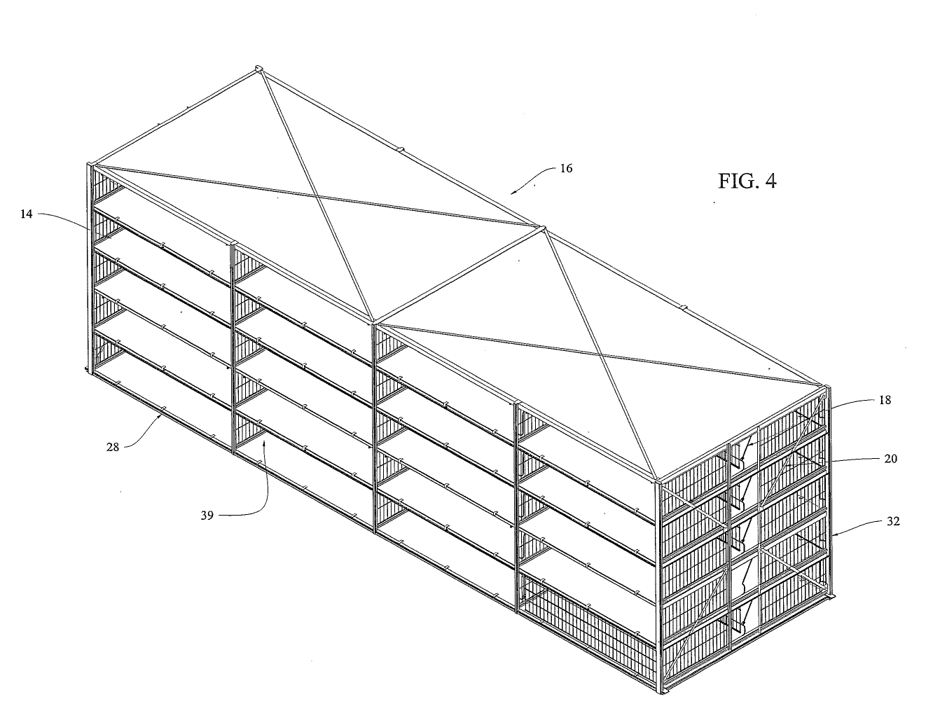

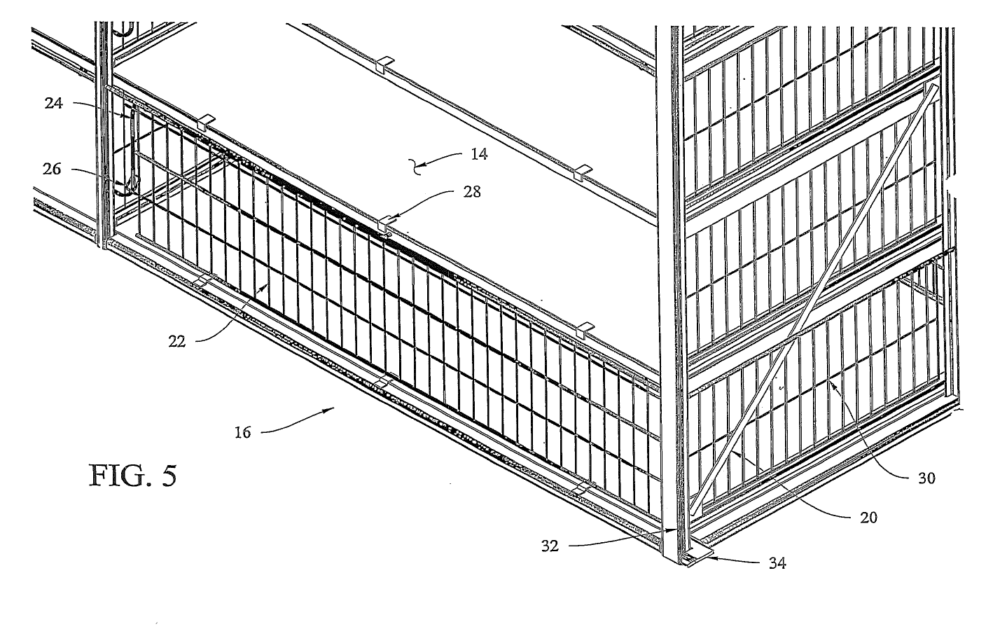

More particularly, an embodiment of the coop module 16 design of the present invention is illustrated in FIGS. 4 and 5. FIG. 4 shows a perspective view of the coop module 16 of the coop trailer 12. This particular module 16 has twenty openings on each side, one for each of the twenty coops 14. However, to reduce construction costs and to conform to different lengths and styles of trailers, modules may be built together or in single rows. Thus modules could have 10 to 40 coops instead of 10, with the possibility of any number of modules per trailer. The coops 14 have openings on either side to enable the telescoping section of the unloading apparatus to extend from either side of the trailer 12 and/or, depending upon field conditions and operator's preference, may also have additional linkage to allow both coop doors to activate the middle partition, thereby allowing the primary indexes of the loader/unloader to extend the complete length of the container. The configuration of the coop is adaptable to a multitude of trailer sizes. For example, a drop deck trailer can utilize five coops stacked on the top deck and six coops stacked on the drop deck. Such a configuration will increase the net hauling weight of the trailer, which in any event is dependent on particular state laws. Additionally, different trailers attached to the coop modules may enhance other safety features such as reducing the center of gravity and increasing stability. The module 16 of the preferred embodiment is currently 22 feet 6 inches wide, but may obviously vary depending upon the length of the trailer 12. Each module 16 is preferably braced for stability with members in the form of an “X” 20 as shown in FIG. 5.

The coop floor support, not shown, is currently a checkered pattern flat iron structure, while the coop floor is thin durable and washable plastic compound. The floor is slid into place from the side and held in place by metal tabs 28 or other means of securement. The floor may be more securely held atop the structure via screws in its middle, or rubber mounts attached above to allow the floor to flex to a minimal bend, particularly during the updraft wind pressure caused during transport without the livestock.

As shown in FIG. 5, the coop door 22 is constructed of thin steel bars in a checker pattern to both give it strength and allow the flexibility to bend while maintaining shape. A runner guide 24 or the like is positioned on both sides of the door currently consisting of a thin rod to side the door 22 opened and closed through the door's ringlets 26 or the like. To prevent any possible damage from the extension of the unloading apparatus, this guide is positioned roughly four inches off the floor. A hook or the like locks the door in the open position to prevent it from sliding down during loading/unloading and to prevent the animals from ensnaring themselves and/or dropping on personnel.

An additional mesh 30 is used for the sides of the coop 14. This mesh 30 is stationary and welded to the tubular steel frame 32 of the module. The size of the mesh is such that it allows free air movement yet small enough where animal parts cannot become entangled during transport and/or loading/unloading. This mesh or the doors may be enclosed by wooden or plastic panels or a flexible curtain (not shown) during inclement weather. These panels or curtains may be stored under the trailer as previously shown in FIG. 1. Each module further includes an engaging device 34, otherwise known in the art as a “skid”, for attaching the module to the trailer via attachment member 13. This engaging device 34 may further serve as a conveyance structure on the chain conveyor as will be discussed in further detail below.

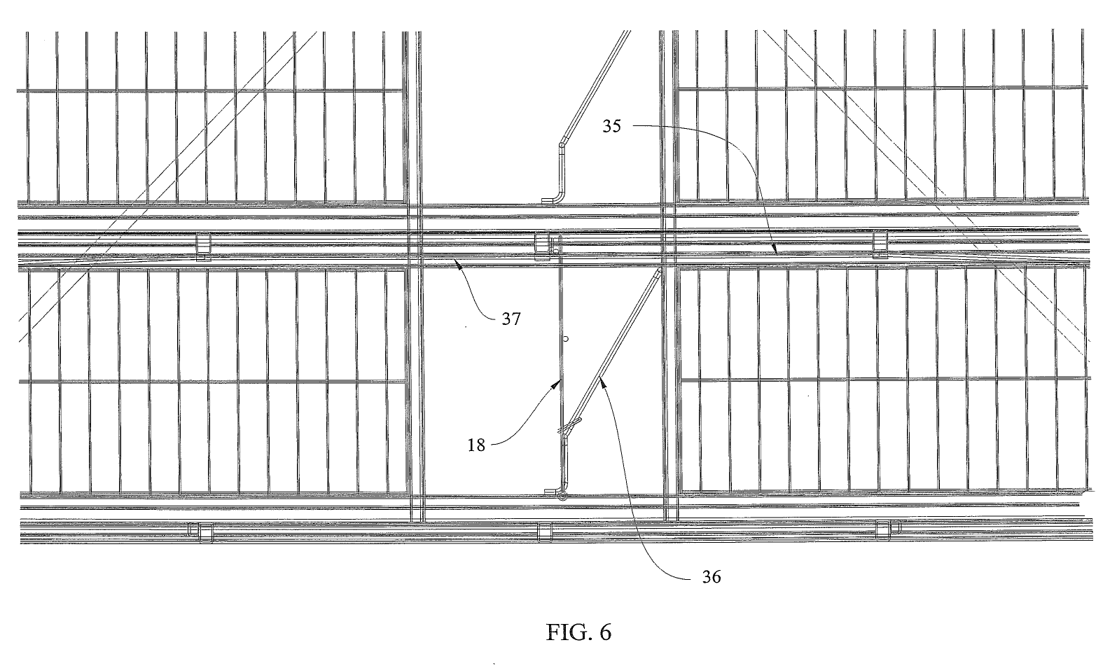

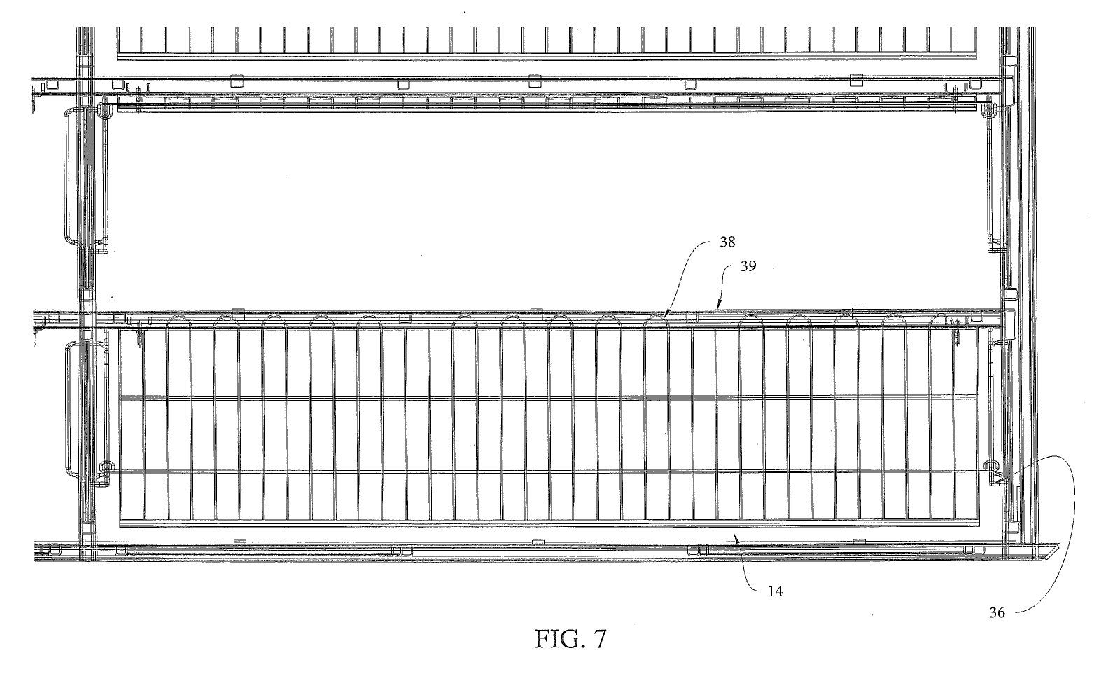

As shown in FIGS. 4, 6 and 7, the coop 14 of this embodiment further includes a partition 18 which may swing and lock in a generally perpendicular fashion. The partition is operatively coupled to the coop door such that partition raises when the operator opens the coop door during either the loading or unloading process. More specifically, as shown in FIGS. 6 and 7, the partition 18 is operable via a linkage 37 with an associated coop door 22. When the coop door is opened, the linkage 37 is operatively coupled to the partition 18 such that the partition 18 slides up the side middle partition door runners 36. The top of the partition 18 rides on a support bar or hangar 35 which is propelled forward by the coop door linkage 37. Therefore, as the coop door is opened, the partition is pushed open. The partition 18 remains in an “up” position (parallel and generally adjacent to the ceiling of the coop) when the coop door is locked in an open position as discussed above. When the coop door is closed, the linkage 37 disengages the partition 18 causing the partition 18 to lower or drop and slide on the support hangar 35 via the force of gravity. Accordingly, the partition 18 would remain in the up position if there is no obstruction from the animal residing therein. It has been shown that during transportation, poultry settle in a crouch position, thus allowing the partition 18 to drop. The lowered partition aids in preventing the animals from shifting from side to side in the coop 14.

The partition 18 is generally situated in the middle of the coop and its structure serves to prevent the animal from shifting while inside the coop. More specifically, the partition 18 is situated such that it does not touch the floor 39 of the coop 14. The top portion of the partition 18 further includes a semicircular top portion or the like 38 and is further situated such that the semi-circular top portion 38 generally engages the ceiling 40 of the coop 14. This arrangement prevents the animals from shifting while inside the coop while further stopping them from entangling their limbs when the partition raises or lowers.

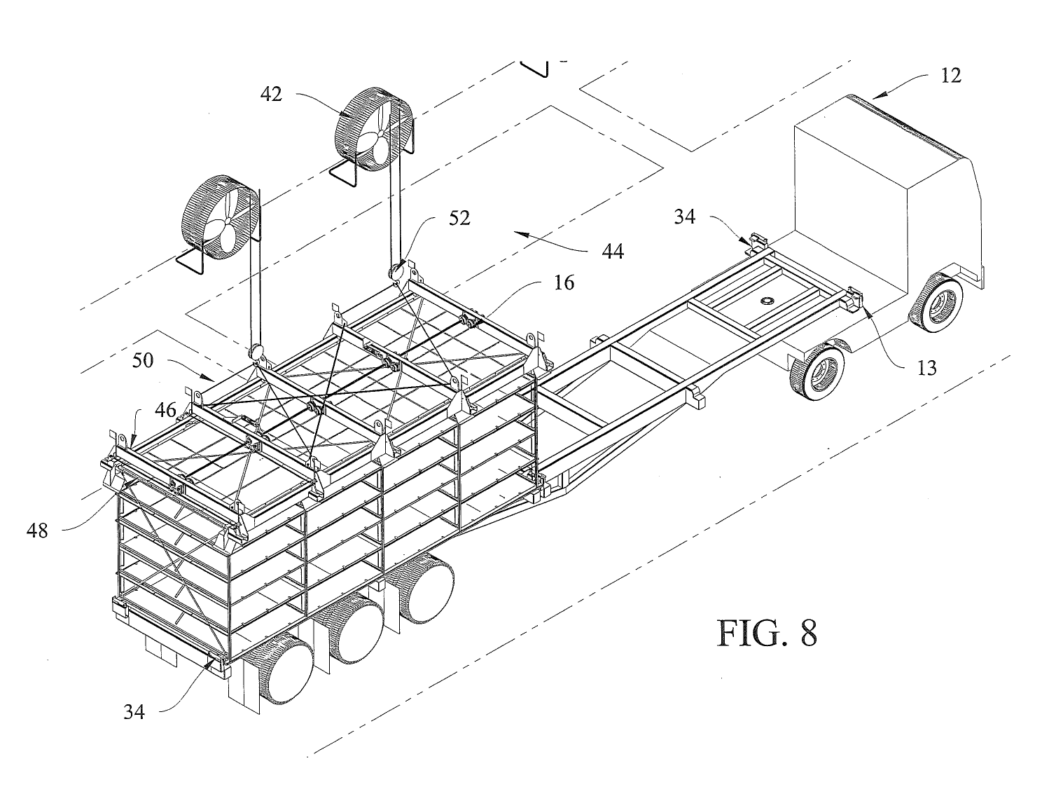

Now turning to FIG. 8, when a transport vehicle 12 reaches a destination employing one embodiment of the present invention, it is generally positioned near an unloader unit. Situated in general proximity to the unloader unit are fans 42, sprinklers, foggers and lighting to control the environmental conditions therewith. Each attachment member 13 is disengaged from an associated skid 34 such that each coop module 16 may be removed from the trailer via an overhead crane 44 including a coop module lifting device 46. The lifting device 46 engages the top portion 48 of the coop module 16 such that the module may be removed from the trailer and moved to an appropriate location. In this embodiment, the lifting device 46 includes a securing wire 50 generally designed to accommodate an overhead crane 44 via hooks 52. Although it may also be designed to accommodate other similar cranes or the like, a twin hoist overhead crane is used in this embodiment. As opposed to a single hoist crane, a twin hoist overhead crane is used in order to accommodate uneven weight distribution and thereby prevent tilting during raising and lowering the coop module 16.

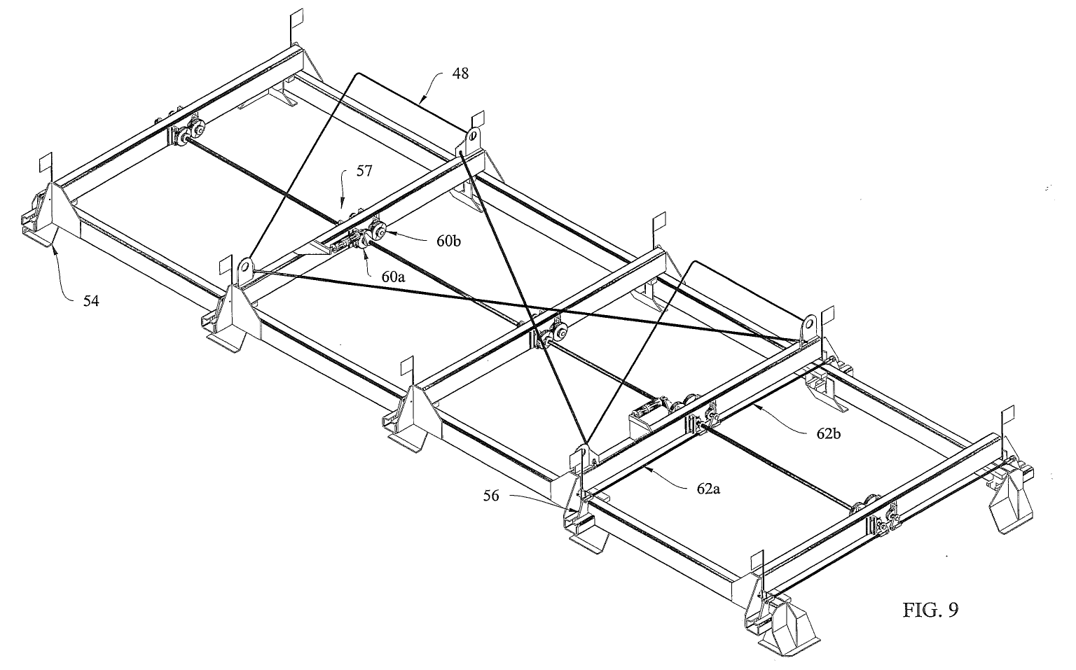

FIG. 9 illustrates the coop lifting device 46. Guide plates 54 are generally situated on the perimeter of the coop lifting device 46. These guide plates 54 aid in positioning the coop lifting device 46 in an appropriate location near the top portion 46 of the coop module 16. The coop lifting device 46 further includes a module engaging member 56 which operatively engages the top portion 48 of the coop module 16. Although, it may be designed in other comparable structures, the module engaging member in this embodiment is in the form of a pin. The coop lifting device 46 further includes a module securing mechanism 57 operatively associated with module engaging member 56.

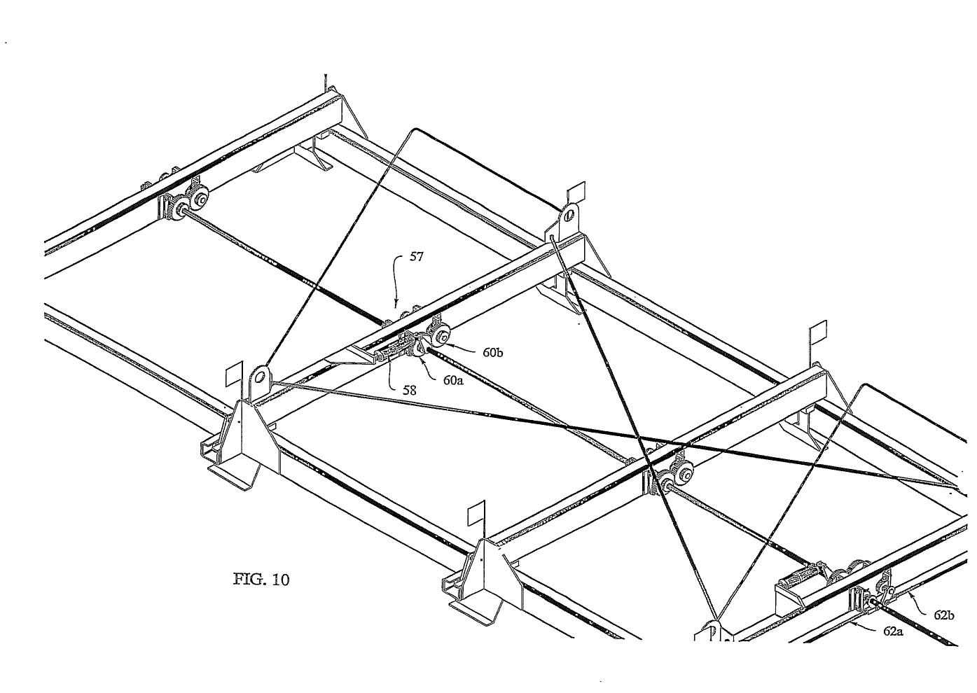

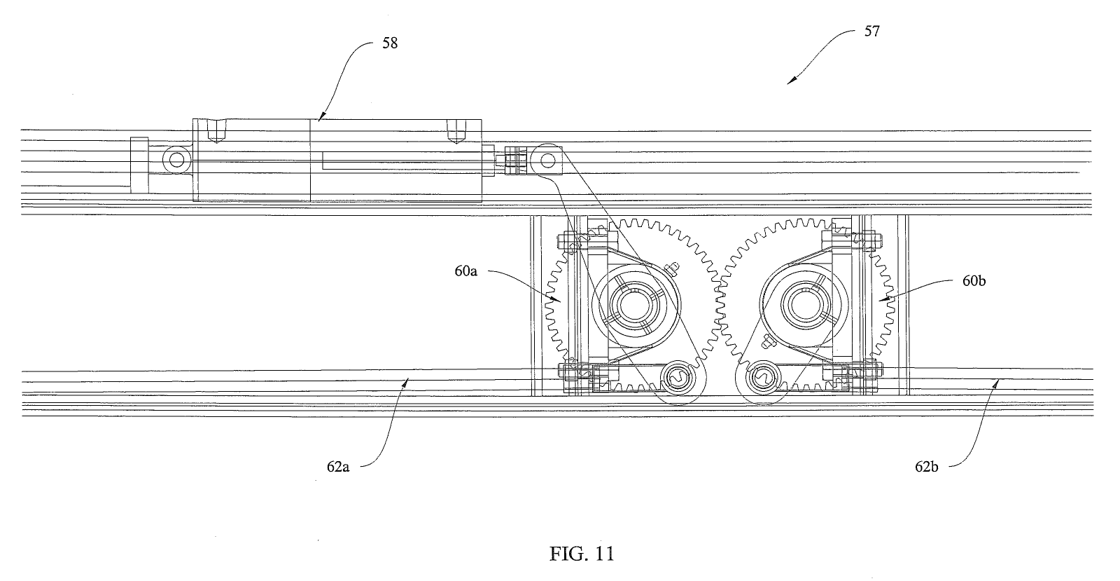

As shown in FIGS. 10 and 11, the module securing mechanism 57 includes an air cylinder 58. The air cylinder (or other power means) 58 is further associated with gears 60a, 60b which move associated rods 62a, 62b. In turn, these rods 62a, 62b are connected to the module engaging member 56 to engage and disengage the top portion 48 of the coop module 16. In this embodiment, when the air cylinder 58 is activated, an increase in air pressure in the air cylinder 58 causes the gears 60a, 60b to move the associated rods toward the outer perimeter of the coop module lifting device 46. In turn, this causes the connected module engaging member 56 to also move toward the outer perimeter of the coop module lifting device 46, thereby causing such to disengage from top portion 48 of the coop module 16. Alternatively, when the air cylinder 58 is charged from the other end, a decrease in air pressure in the air cylinder 58 causes the gears 60a, 60b to move the associated rods toward the center of the coop module lifting device 46. In turn, this causes the connected module engaging member 56 to also move toward the center of the coop module lifting device 46, thereby causing such to engage from top portion 48 of the coop module 16. The coop module engaging member 56 is spring loaded in case of a power outage or loss of air pressure so that the engaging mechanism does not unexpectantly release the coop module.

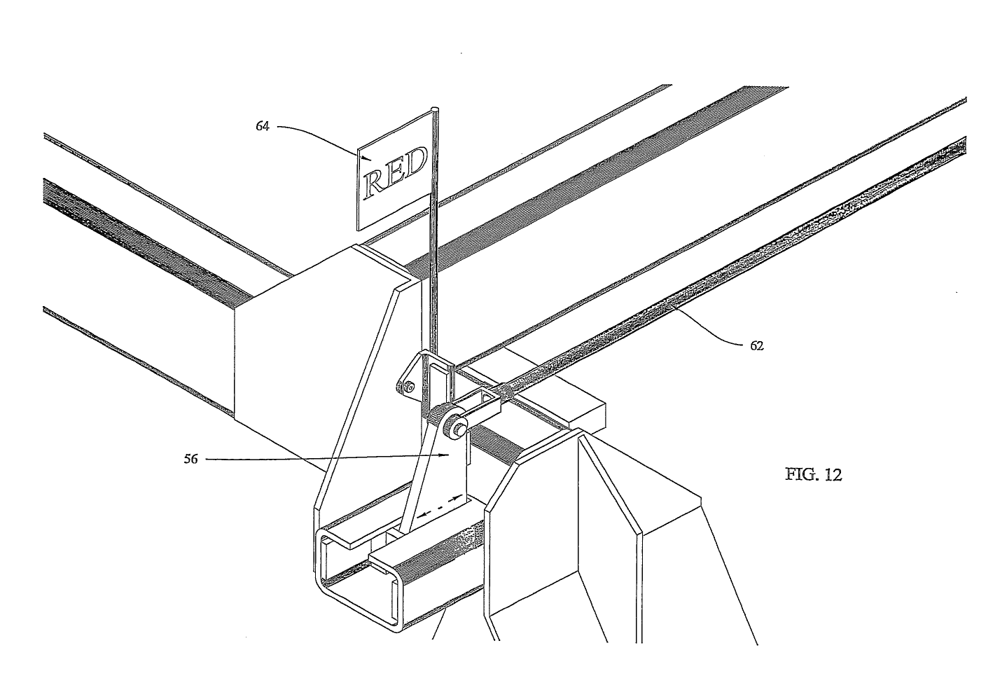

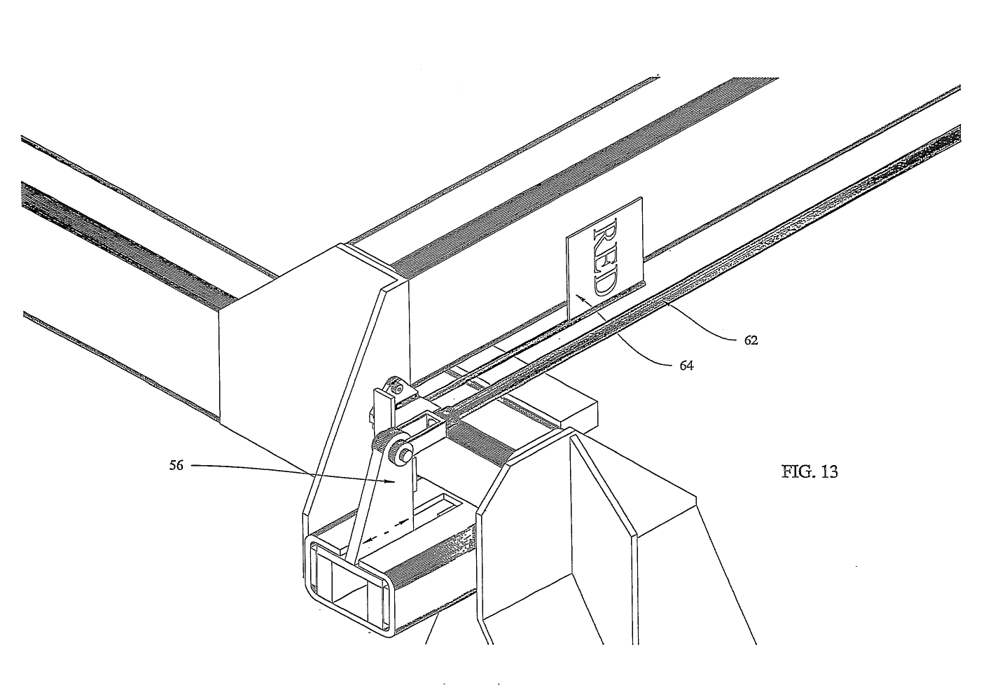

As shown in FIGS. 9, 12, and 13, further associated with each module engaging member 56 are indicators for signaling when the module engaging member 56 has substantially engaged the top portion 48 of the coop module 16. In this embodiment, the indicator includes a flag 64, which raises when the module engaging member 56 engages the top portion 48 of the coop module 16. Alternatively, the flag 64 lowers when the module engaging member 56 disengages the top portion 48 of the coop module 16.

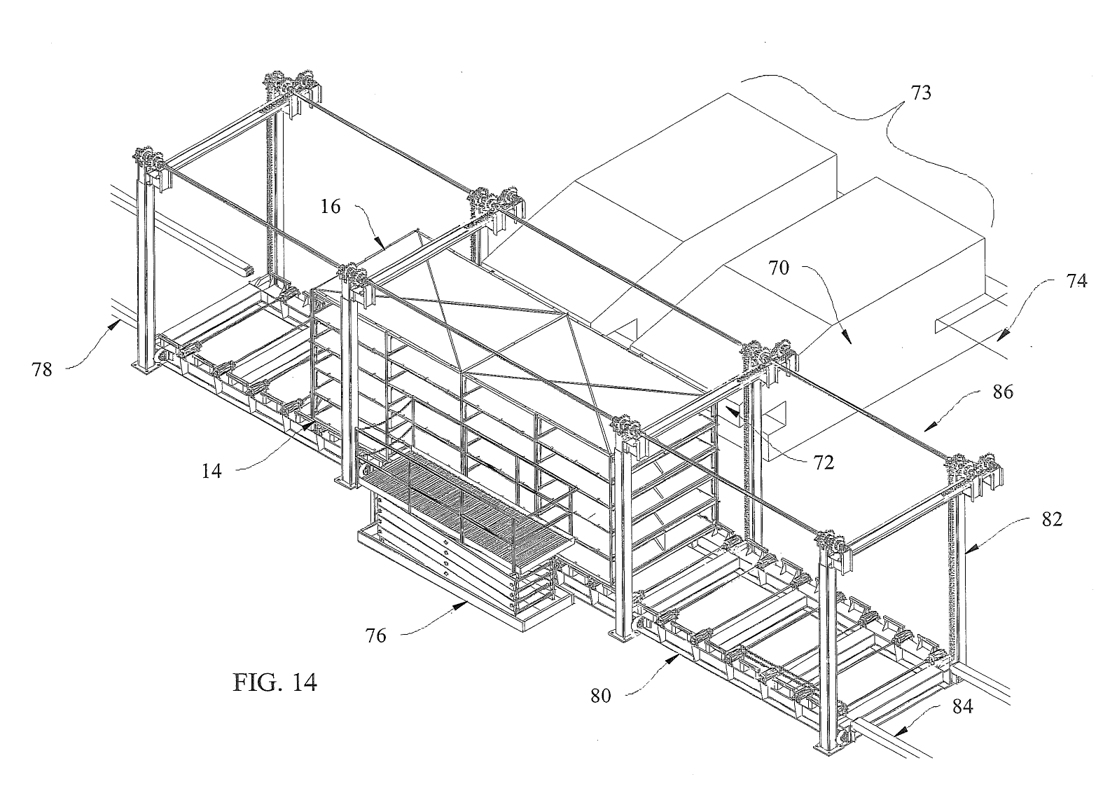

With the above mentioned lifting device 46, each coop module 16 may be removed from a trailer, moved, and placed near a base unloader unit 70. As shown in FIG. 14, primary indexes 72 extends from the base unloader 73 into the coop 14 in order to unload livestock. It is important to note that the primary index 72, may be raised, lowered, extended, or retracted. The primary index 72 is surrounded by a cleated plastic conveyor belt which when inserted into the coop 14, will pick the poultry up from the coop floor and transport them towards the base unloader unit 70 where they will be transferred onto a generally perpendicularly positioned discharge belt 74.

The base unloader 73 of the present embodiment unloads the livestock much like the unloader disclosed in applicant's recently allowed U.S. patent application Ser. No. 10/044,675, hereby incorporated herein by reference. More particularly, when the coop module 16 is positioned adjacent the unloader 73, at least one primary index 72 extends into a coop. It is important to note that the primary index is fully extendable into the coop and therefore enables the unloading of a coop module 16 from a single side without the need to re-position the coop module to unload from the other side. Once a coop is emptied of livestock, the primary index can be repositioned to empty the remaining column of coops. Once a full column of coops is emptied of livestock, the coop module may be repositioned on the conveyor 80 to empty the next column. Alternatively, the base unloader 73 may have multiple indexes and accordingly be capable of unloading more than one column and coop at a time.

Once the livestock leaves the coop module 16, they can be conveyed to an unloading station and/or a preshackle stunner before they are moved on to final processing. At the unloading station, individual livestock information may be gathered (i.e. weight, DOA, etc.) for later further analysis. The preshackle stunner may be of the typical CO2/O2, nitrogen, electric, and/or other means. Once these steps are complete, the livestock is ready for further animal processing.

Opposite the primary index 72 is a movable platform 76 to facilitate in the unloading process. By raising and lowering of this platform 76, an operator may easily access each coop. Accordingly, an operator helper may release a lodged animal and may further access each coop via opening the coop door to assist in the washing and disinfecting of the coop module. In addition, the operator can manually raise the partition 18 by inserting a hook and pulling the top 38 of the partition and temporarily lock the middle partition in the up position during the unloading process. In any event, during this process, the coop module 16 is further positioned on a coop module transfer conveyor 78. The section of conveyor 80 associated with the base unloader 74 and the coop module 16 situated thereon are raised and lowered, or otherwise moved away and toward the primary index 72 via a hoist 82, in order to facilitate the aforementioned unloading process.

The conveyor 80 has predetermined stops for the coop module to stop at a position for the primary index 72 to extend cleanly the length of the container for each column of the coop module. In addition, as base unloader units 70 are utilize, predetermined stops are designed for all columns of the coop module in case one or more base unloading units 70 primary indexes malfunctions. Synchronization component 86 insures a true vertical and descending motion of the coop module in relation to the base unloader units 70 primary indexes 72. This will allow for the primary index 72 to slide evenly over the coop floor 39 and preventing feathers or toes from being pinched. Means other than hydraulic cylinders could raise the conveyor 80 and other means could be implemented to maintain the conveyor vertically true to the base unloader unit primary indexes.

After unloading and processing, the coop module is conveyed to another section of the conveyor 84 for washing or disinfecting. The clean coop module may further be transferred back to a trailer via yet a lifting device similar to that described above.

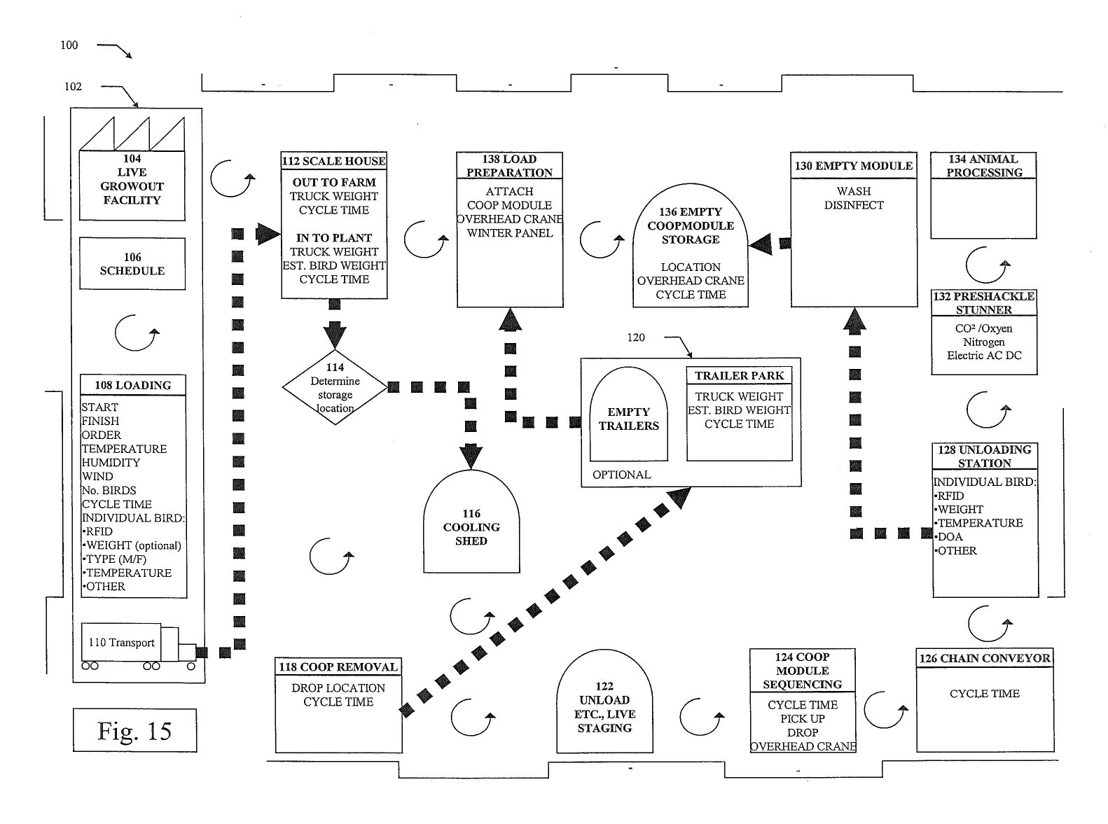

The flow diagram, or value stream map, of FIG. 15 is an example of a complete cycle of use 100 of the present invention from live growout facility to processing plant and back again. More particularly, the components of the value stream map of FIG. 15 show the flow of objects, whether they are livestock, coop modules, coop trailers, tractors, loaders/unloaders, etc., from point to point throughout the cycle. The flow before arrival at the scale house is shown within the pre-arrival process 102 and includes the live growout facility 104, scheduling 106, loading 108 and transport 110. Information about the transport is then gathered at the scale house 112 and used to determine the storage location 114 of the transport. This location is either a cooling shed or the like 116 or straight to coop removal 118.

Depending upon plant parameters, coop modules are removed from the trailer and the trailer may be stored at an optional trailer park 120 until such time as it is called to load preparation 138. In any event, the modules are moved to a staging area 122 before the overhead crane picks them up at module sequencing 124 and delivers them to the chain conveyor 126.

The unloading station 128 removes the livestock from the modules as described above and delivers the modules to the wash/disinfect area 130 and the livestock to the preshackle stunner area 132 and on to animal processing 134. After the modules are washed and disinfected at 130, they are stored 136 and perhaps serviced/repaired before they are attached back to a trailer at load preparation 138.

The present invention has also been designed for ease in tracking and data collection, and in particular takes into account the numerous advantages of radio frequency identification (RFID), for example. RFID is an example of a system that can be used by the present invention for tagging and identifying both static sites/objects and mobile objects (i.e. live production sites, unloading facilities, loading sites, coop containers, coop modules, coop trailers, semi-trailers, livestock, loaders and unloaders) so that they can be labeled and tracked as they move from place to place. At the loading station 108, for example, such personal animal information like weight and individual temperature, as well as other more general information like location, start time, finish time, temperature, humidity, barometric pressure, number of animals, etc. can be documented with the use of a personal digital assistant or other electronic recording/transmitting means or possibly non-electric means. Similarly, at the unloading station 128, the same information as well as other information (i.e. DOAs, body temperature and individual weight) can be documented. Theses types of tracking systems can take into account the possibility of future improvement of data gathering within the livestock itself that could collect/analyze information (i.e. hormone and enzyme levels, antibodies, specific animal traits, etc.).

While the present invention will be shown and described through the use of RFID, it will be understood that other forms of identification has also been contemplated, and the invention is therefore not limited to the use of RFID. In any event, RFID systems are typically comprised of a series of RFID tags which upon request will provide specific information to an RFID reader. RFID tags come in three varieties: passive, active, and semi-passive. The primary difference between the three types is the RFID tag power supply. The passive RFID tag has no internal power supply, and operates by using power taken from the RFID reader to provide sufficient energy to transmit the information stored in the passive RFID tag. The information that is transmitted is stored in a circuit within the passive RFID tag and is transmitted from an antenna on the passive RFID tag. The information stored in the tag may be as simple as an identification code to identify the object being tracked, or the information may be any non-volatile data.

Active RFID tags have an internal power supply for powering internal circuitry and broadcasting the RFID signal from the tag itself. Active RFID tags can broadcast a stronger RF signal, as opposed to passive RFID tags, to be read by the RFID reader. The ability to broadcast a stronger signal is desirable in locations that would be considered harsh RF environments. An active RFID tag may also have sensors to take data from the item being tracked by the RFID system. Furthermore, the active RFID tag will be able to transmit information stored in the circuitry of the tag, such as an identification code, and any data both volatile and non-volatile.

Semi-passive RFID tags have an internal power supply which does not power the transmission from the antenna to the reader. The internal power supply only powers the circuitry that receives the signal from the RFID reader, the circuitry that stores data, and the sensor circuitry that measures data from the item being tracked by the RFID system. Much like the passive RFID tag the semi-passive RFID tag can transmit information such as an identification code and non-volatile data; however, the semi-passive RFID tag can also transmit volatile data as well because of the power supply on the tag. The only real drawback of the semi-passive RFID tag from the active RFID tag is the broadcast signal from the semi-passive RFID tag is a much weaker signal and will not perform as well in harsh RF environments.

An RFID reader is a device that is usually configured in some kind of loading/unloading or tracking system to read information from RFID tags. The RFID reader will be composed of circuitry and an antenna capable of communicating with an RFID tag. Information is gathered from RFID tags communicating with the RFID reader and stored and processed by the larger system used in the particular RFID system.

A further embodiment of this invention would use a variation of the RFID system, described above, to track and provide specific information about the trailers, coop modules, coop containers and individual animals being transported. From FIG. 15, the loading stage 108 can be modified to track conditions important to the trailer, coop module, coop container and livestock during the transportation stage 110. During the loading stage 108, an RFID tag on the coop module (for example) would transmit information to the RFID reader. The information sent would tell the RFID reader what type coop module was currently being handled. The RFID reader would be set up to communicate with a computer located on the operator platform which would be capable of informing the loader operator of specific loading information such as recommended density of livestock per coop container as a function of temperature, humidity, and wind speed. The time at which the coop module was loaded would also be associated with the coop module and transportation trailer RFID tag. Also, the RFID system would know the weight of the coop module associated with the RFID tag on a particular module.

Furthermore, it is envisioned that the livestock can be fixed with an RFID tag as well. These tags could possibly be inserted below the skin of the animal at birth or attached to the outer part of the animal during the live production period. These tags are then removed during processing. At the loading stage 108, the livestock will be measured, and the data will be associated with or without the specific RFID tag identifying the particular animal. Such measurements would at least consist of the weight of the particular animal. Also, the RFID tag on the livestock will be tracked in the system to tell what particular coop container the animal is in, the coop module the animal is in, what trailer the animal was transported on, what barn the animal came from, and what flock the animal was part of.

At the unloading station 128, the RFID reader will see what specific coop containers and coop modules are being unloaded and detect what livestock is present in the module. At this point, the coop module with the livestock still contained within can be weighed. From this measurement average shrinkage can be calculated by the system. Also, the time at which the trailer/coop module arrived at its destination would be logged thus allowing total transportation time to be associated with a particular animal. Also, as the livestock is unloaded, further measurements may be taken; these measurements will be correlated to earlier measurements done at the loading stage 108. For example, the correlation will enable the system to identify how much the specific animal shrank during the transportation. Also, animals that are dead on arrival (DOA) will be detected and located in a particular coop or coops per coop module at the unloading stage 128. The system will associate the DOAs with their specific identification in the RFID system.

All the information tracked with the livestock will be stored as data associated with a particular animal. If information is ever needed on a specific animal because of a complaint or a food safety issue, the individual animal data will be readily accessible. The information stored could consist of what barn the animal was raised in, what flock the animal was part of, what trailer the animal was transported in, what the weather conditions were during transportation, the livestock density of the particular coop module that transported that animal, how long the livestock was in transportation, and how many DOAs were detected in the transportation of that particular trailer or coop module. All of the above information would be extremely helpful if a recall of particular livestock was needed. Another novel use this information of live animal well-being would be relayed to the consumer where consumer purchases via retailers would have objective measurements to determine how and what conditions the animal was produced. A retailer and/or wholesaler can accordingly design a procedure consisting of any parameters to use the individual and group data as a strong selling point to an ever concerned animal conscious consumer. Through use of the present invention, synchronized with an implant tracking/data collecting system, management personnel, who until now have had no hands on knowledge of the process and procedure from farm to consumer, can now, with their own first hand knowledge, make sure their company not only meets all standards but they will also have the evidence to assure their customers and the end consumers.

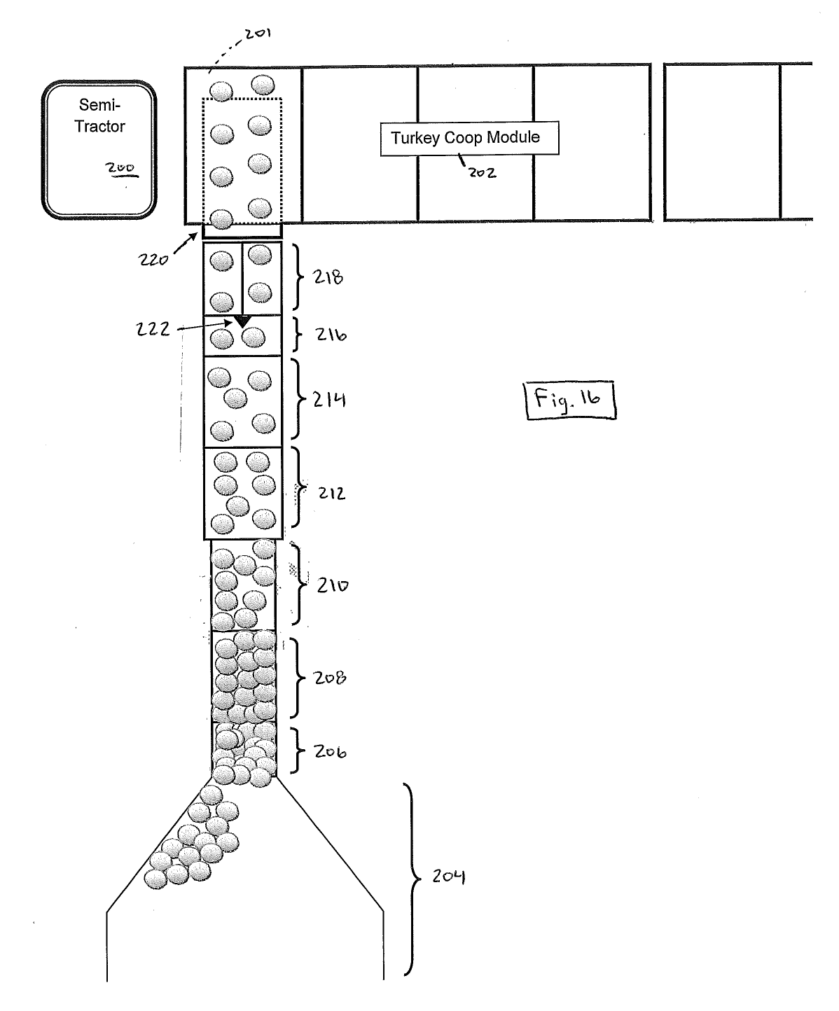

FIG. 16 illustrates the loading of individual containers 201 of the coop modules 202 on the tracker 200. In one embodiment the livestock loading device could be used to load turkeys. In this case, individual containers are large and few compared to a coop module and containers transferring chickens, in which, smaller and more individual coop containers are necessary. In any event, it will be understood that the loading device of the present invention can be used to load any type of livestock. The loading device in FIG. 16 consists of a storage pen 204 followed by a series of transports or conveyors which are used to eventually arrange individual livestock thereby being able to measure particular data pertaining to the livestock, before placing the livestock into the coop.

More particularly, the storage pen 204 is where the livestock is herded prior to being funneled into the feeder conveyor 206. Livestock that cannot be herded, chickens for example, utilize a special apparatus that picks up the live chickens from the barn floor and deposits the live chickens on main frame conveyor 212. Accordingly, conveyors 206, 208, 210 would be eliminated for chicken use. In any event, at this point the livestock is excessively crowded as they are funneled into the feeder conveyor 206. The subsequent series of conveyors (e.g. 208, 210, 212 and 214) will redistribute/reposition the livestock in order to uniformly disperse the animals into at least two singulation lanes for data collection and to uniformly fill the individual coop container 201 within the coop module 202. The number of singulation lanes is determined by the size and density of the livestock being transported. Smaller livestock (e.g. chickens) will result in more singulation lanes, and larger livestock (e.g. turkeys, swine and cattle) will result in fewer (if not one) singulation lanes.

In the present embodiment, feeder conveyor 206, pre-loader conveyor 1 208, pre-loader conveyor 2 210, main frame conveyor 1 212, main frame conveyor 2 214, head section conveyor 1 216, head section conveyor 2 218, and the reciprocating conveyor 220, each having their own speed controller, which may be all controlled by a processor or computer, although it is possible to control by manual means. The computer controls the speed of the successive conveyors so as to accomplish the singulation and distribution of the livestock in such a manner where individual data could be collected. In addition to the speed of the conveyors, singulation is aided by a deflection device 222, located in the head section conveyor 1 216, which helps to push the livestock into a specific singulation lane. Alternatively, deflection mechanisms could be installed in different locations within the conveyor chambers to facilitate the positioning of the animals. The number of deflection devices 222 present can be altered for the specific size of the livestock being loaded.

As can be seen in FIG. 16, by varying the speeds of the various conveyors from the feeder 206 (or mainframe 212) to the head section conveyor 1 216 livestock that were initially crowded and uncapable of being individually measured, are now arranged for easy individual data collection. This is accomplished by separating individual livestock from the group of livestock enough so that there is an adequate gap or space between individuals to effectuate individual data collection. It will be understood that while the loading process is shown to utilize six (6) different conveyors to reach singulation lanes and thus data collection, it is envisioned that fewer (or even more) may be utilized. Further, although the present invention utilizes various conveyor belts as its means of livestock transport, it is contemplated that other means and methods of transport may be used.

Data pertaining to the animal position is collected as the livestock is being transported down the series of conveyors. More particularly, the data is gathered from a battery of strategically placed sensors along each conveyor path to determine the group density at that particular point. This data will enable the effective speed control of each conveyor so as to gradually thin out the crowded group of livestock and attain singulation and the ability to collect data on individual livestock.

In FIG. 16, the reciprocating conveyor 220 will place the livestock into an individual coop container 201 in the coop module 202. By the time the livestock reaches the reciprocating conveyor 220 all relevant data will have been collected, and the specific number of singulation lanes will be populated with the livestock evenly to attain individual data.

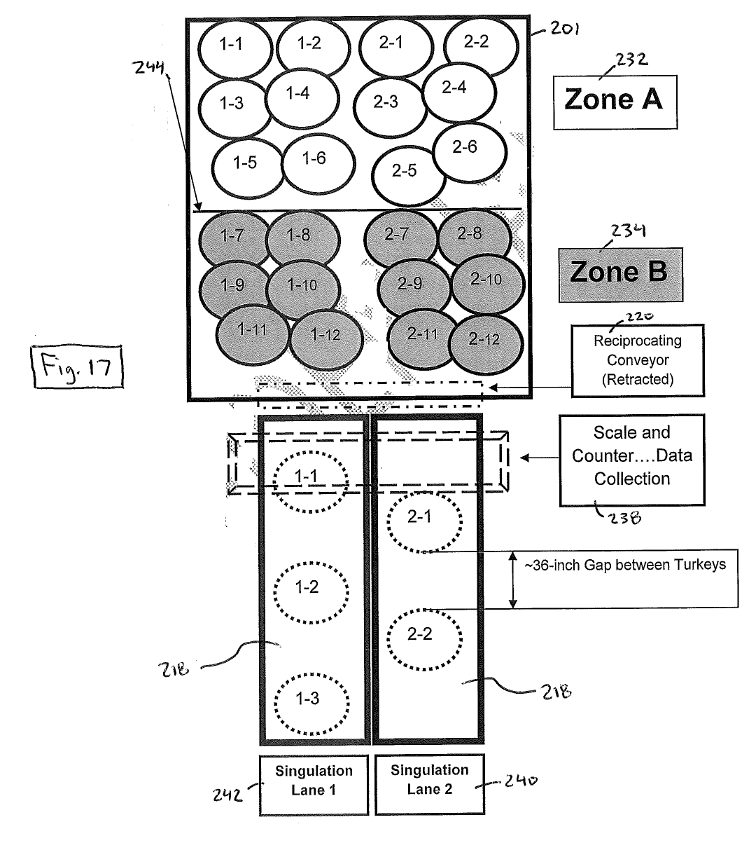

FIG. 17 illustrates a more detailed version of the livestock placement within an individual coop container 201 in a coop module 202, and head section conveyor 218 from FIG. 16. In this particular example, the scale and counter 238 is shown at the end of the head section conveyor 218. The data collected at the scale and counter 238 will at least consist of the weight of the individual animal. This specific data is collected at the head section before the birds are dumped on the reciprocating belt 220 filling the individual coop container 201. Furthermore, the measurements could be expanded to take into account future improvements in sensor technology that would allow measurements of hormone and enzyme levels, antibodies, specific animal traits, blood/oxygen levels and potentially many other data points of interest pertaining to the livestock being transported. All of the measured data will be associated with the specific animal it came from either through its specific location within a uniquely identified coop container 201 that could have a RFID tag in the coop module 202 or from a specific RFID tag used to track the animal during transport. This data is stored in a memory device that may either be independent of or part of a processor.

The scale and counter 238 weighs and counts the livestock as they are loaded into the individual coop container 201 in the coop module 202. This arrangement allows the operators to take live weights of all individual animals while the line is moving and without interrupting animal flow. The livestock is counted in order to determine how many animals are left to load into the individual coop container 201 in a coop module 202. The individual animal weight is associated with the livestock either by individual identification or by keeping track of the animals' location within the coop container 201. Furthermore, the loaded individual coop container 201 is weighed as well as the loaded coop module 202 is weighed, and the data is stored to use later in calculating shrinkage once the coop module 202 has arrived at the unloading facility.

In order to keep track of the livestock during transport the individual coop container 201 is composed of two zones. The two zones within each coop container in a coop module 202 are zone A 232 and zone B 234. Singulation lane 1 242 and singulation lane 2 240 load the livestock into the individual coop container 201 in the manner depicted in FIG. 17. Each oval within the individual coop container 201 and singulation lane 1 242 and singulation lane 2 240 represents an individual animal with 1-1 being the first animal loaded into the individual coop container 201 from singulation lane 1 242 and 1-12 represent the last animal (the invention described herein does not require twelve animals, more or less animals can be transported in this manner). A similar number scheme exists for singulation lane 2 240 except the livestock is labeled from 2-1 to 2-12. In transit, livestock migration is largely controlled by using a middle partition 244 within the individual coop container 201. The middle partition 244 prevents livestock from zone A 232 moving into zone B 234 and vice versa. The livestock may switch positions within their zone within the individual coop container 201; however, most of the time the animal will not migrate or move around in transit. In fact, and with turkeys in particular, they rarely stray far from a space of a few feet in diameter. Therefore, during the individual coop container 201 unloading process, it is not atypical that the first animal unloaded will be the last animal loaded, and on through the last animal unloaded being the first loaded. This assures the ability to assign each bird a number for processing.

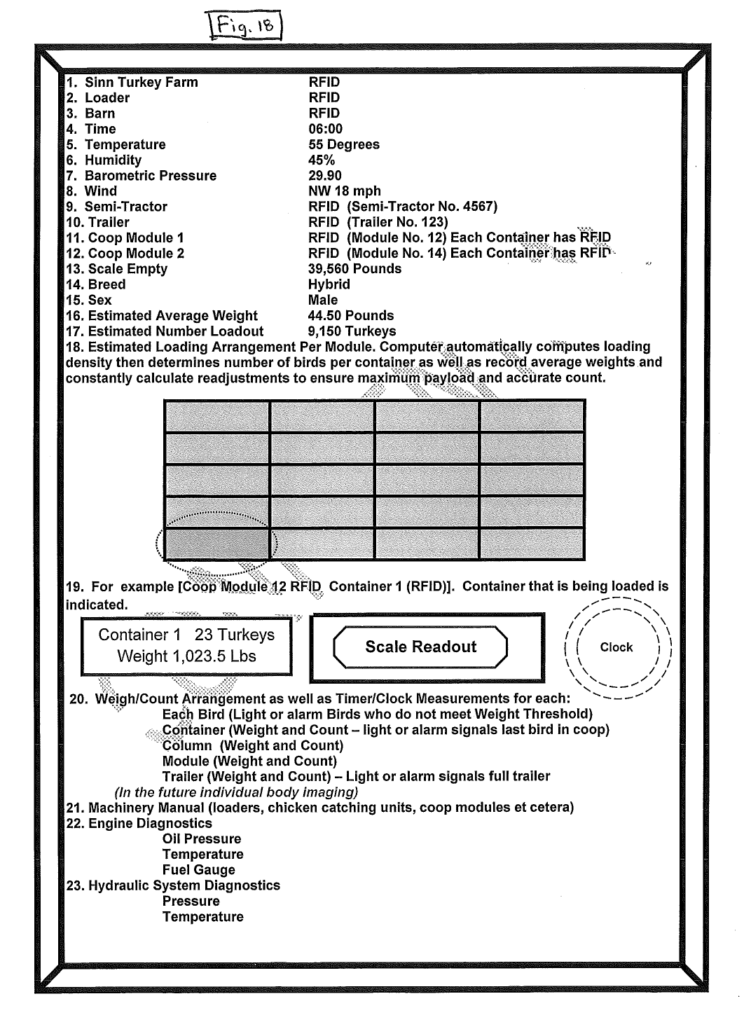

FIG. 18 shows a potential layout for the operator's screen of the computer controlling the loading process, including conveyor speeds, data collection, etc. The computer will record and display weather conditions such as temperature, humidity, barometric pressure, and wind speed. The computer will also indicate the breed of the livestock along with the sex of the individual animals being loaded. Furthermore, the computer will provide the estimated weight of the animals along with the number to be sold so as to indicate the number of transportation units required to ship all of the livestock to its destination. As the livestock is loaded into the transportation units the weight of the animal is measured and recorded, as previously discussed. The total weight per individual container 201 and coop module 202 is kept track of by the computer. Once the total weight reaches the estimated weight the computer will indicate, to the operator, that the stopping point has been reached, and the conveyors are deactivated.

The operators' screen also provides a readout showing the diagnostics of the overall system. The system in the preferred embodiment is an electrically controlled hydraulic system. Therefore, indicators such as the overall temperature of the system and the oil temperature amongst others will be displayed on the operator's screen.

The operator's screen can also be tied into the RFID system. The various RFID tags will indicate important information about the condition of the equipment being used. The operator's screen will let the operator know how densely packed the livestock should be for transportation. Furthermore, through the RFID system the operator's screen could indicate exactly what animals are being loaded into a specific coop container and coop module and record that information for later use.

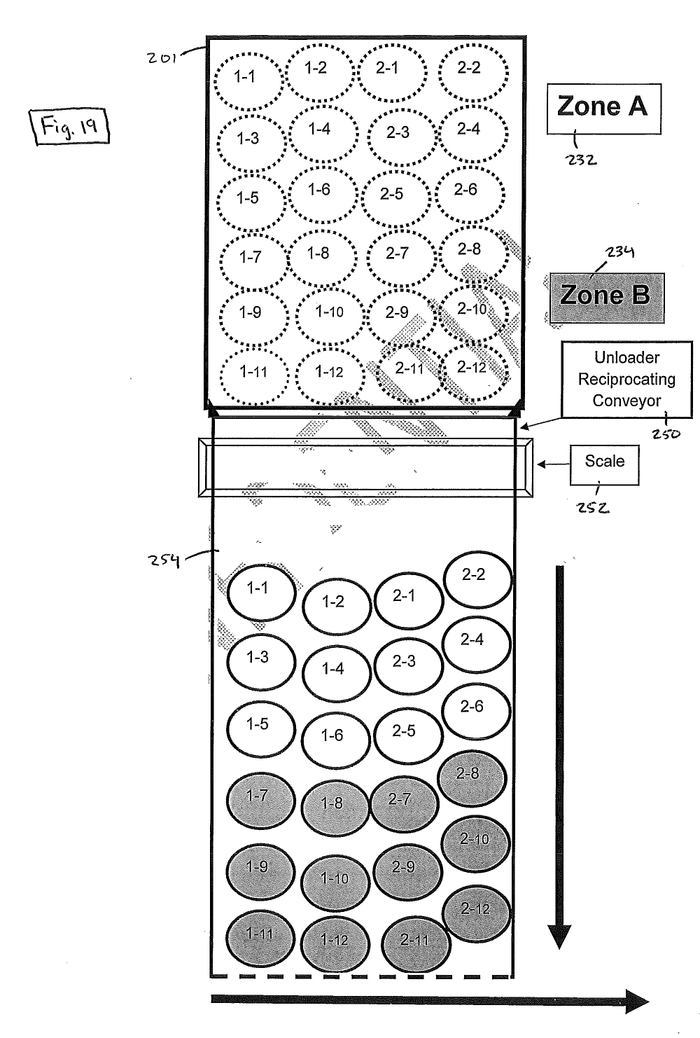

FIG. 19 illustrates the individual coop container 201 within a coop module 202 at the unloading station. The arrangement of the animals is the same as the arrangement discussed in FIG. 17. Therefore, as stated before the last animal loaded will typically be the first unloaded. This procedure enables information, such as weight, to be known about specific animals such as high and low in each zone 232 and 234 as well as individual weight distribution per zone and individual container. It is contemplated that individual animal information could be accomplished by RFID tracking or other individual tracking tools of the individual animals and transportation devices. Furthermore, the entire coop module 202 will be placed on a scale 252 so the entire weight of the module can be measured. The measured weight will be compared to the weight of the module and/or individual coop container at the loading station to obtain the total amount of shrinkage during transit. Shrinkage is an important factor in determining overall stress to the livestock during transportation.

After the coop module 202 arrives at the unloading station shown in FIG. 19 the operator will activate the unloader reciprocating conveyor 250. The unloader reciprocating conveyor 250 is the conveyor that extends into the container and begins to remove the livestock from the individual coop container 201 within the coop module 202. The scale 252 then weighs the livestock prior to continuing down the unloading conveyor 254.

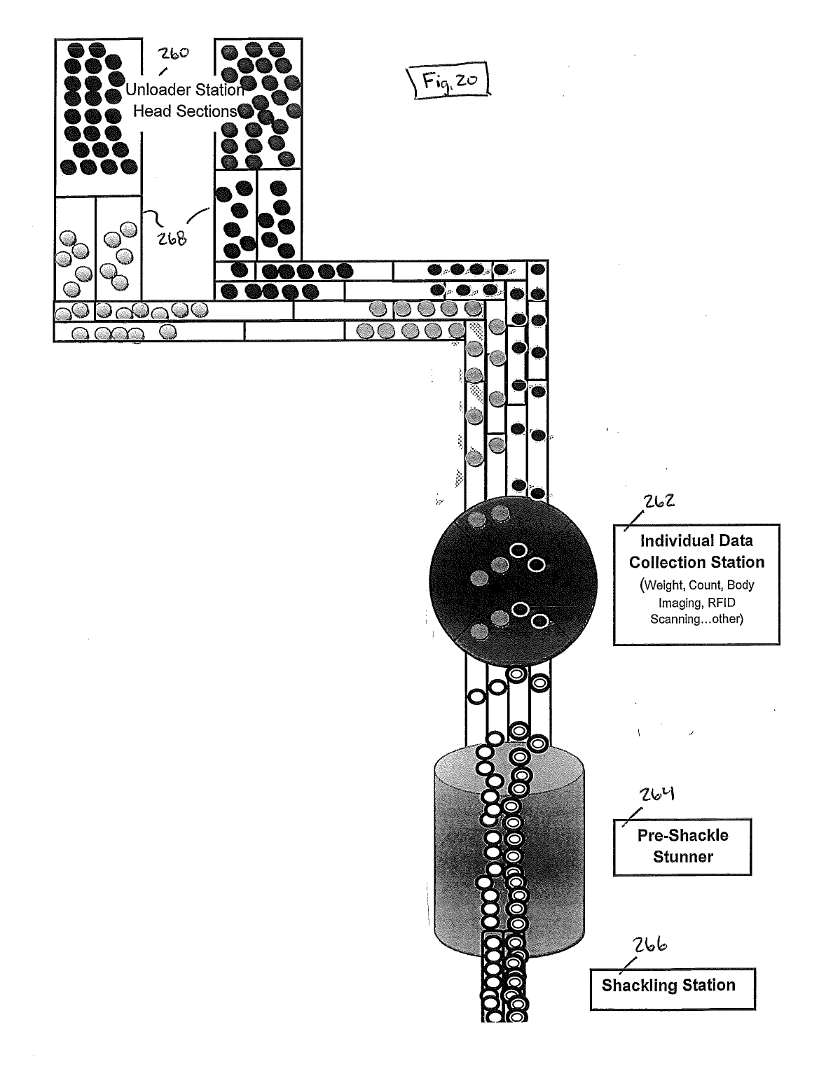

FIG. 20 illustrates the preparation of the livestock for individual data collection and the pre-shackle stunner. A series of conveyors, which begin with the unloader station head sections 260, divide the livestock into one or more lanes which feed into the individual data collection station 262 and pre-shackle stunner 264. Sensors on the conveyors control the speed of the conveyors so as to evenly space the animals on the conveyor lines.

In FIG. 20, the individual data collection station 262 receives animals from the conveyor lines 268. The individual data collection station 262 performs measurements on the animals and keeps a running count of the number of animals unloaded. Measurements such as DOAs, body temperature, blood/oxygen, bone structure, body scanning, enzyme detection, DNA cursors and other along with individual weight will be performed on each animal. The ability of the processing plant to connect its equipment with the farm and loading equipment provides the traceability from a particular animal at a particular farm to retail grocery. Accordingly, data collected at the farm and data collected at the processing plant and data collected at the retail store can all be compared and traced. For example, the typical system to track the life of a turkey may include: hatching, brooding and growing, handling, driver routes, handling, processing, and on to retail grocery. The present invention accordingly provides for a true tracking transparency. Government agencies, management personal, end consumers, etc. will be able to trace the full history of particular livestock from genetics to hatchery to live production to processing to retailer to consumer. After the individual data collection station 262, the system of conveyor lanes 268 will carry the livestock to the pre-shackle stunner 264 which stuns the animals prior to being shackled. After the pre-shackle stunner 264, the livestock is carried to the shackling station 266, and then on for further processing.

FIG. 20 illustrates a preferred embodiment of the invention described herein by showing multiple conveyor lanes 268. A multitude of lanes is preferred because it will help to protect against potential interruptions at the unloader station head section 260. The multitude of lanes are designed to endure interruptions of supply and accordingly the invention will be able to keep a constant stream of livestock into the individual data collection station 262 and more importantly the shackling station. Accordingly, the invention ensures that every shackle will have an animal.

An unloader computer, similar to the operator's computer in FIG. 18, will be present at the unloading station. The unloader's computer will provide the operator control of the conveyor lanes 268. Furthermore, the operator's computer, at the unloading station, will keep track of the data as it is collected from the individual data collection station 262. The data will be associated with a specific animal either by keeping track of the order that the animal was removed from the coop module 202 or through an individual marking system such as a RFID system. Through the use of RFID or other individual tracking tools, the relevant information about specific animals will be readily available upon request from supply chain, retailers and consumers. As such, the present invention attains data, tracks and verifies livestock on a per container basis (if not on a per bird basis) from farm to processing plant. Consumers that are now demanding verifiable assurances will be able to trace the meat they eat all the way back to the farm (or even the egg and/or egg lineage) and become aware of everything that may have happened in between. Taking the invention to the next step would allow agencies/groceries/consumers to pinpoint any problems (i.e. sick birds) and minimize the attempted solutions. Further, individual birds may be capable of being individually tracked; birds may be diverted as rejected at the farm; and/or birds may be individually sorted, marked and diverted at the plant.

While particular embodiments of the invention have been shown and described, it will be obvious to those skilled in the art that changes and modifications may be made therein without departing from the invention in its broader aspects, and, therefore, the aim in the appended claims is to cover all such changes and modifications that fall within the true spirit and scope of the invention.

1. A system for collecting data of individual livestock from a group of livestock, the system comprising:
a plurality of successive transports for receiving the group of livestock, each transport having a speed controller associated therewith wherein said controllers vary the speeds of the transports such that individual livestock are separated from the group of livestock; and
a data collector for collecting data on said individual livestock.

2. The system as defined by claim 1 wherein said transports are conveyor belts.

3. The system as defined by claim 1 wherein said data collector is a scale.

4. The system as defined by claim 1 further comprising a plurality of transport sensors providing group density information to a computer processor whereby said processor automatically controls the speed of the transports to achieve individual separation from said group.

5. A system for tracking livestock, the system comprising:
a storage device for storing a first set of data of individual livestock within uniquely identifiable containers;
a data collector for collecting a second set of data on said individual livestock upon unloading from said container; and
a computer processor for comparing the sets of data and providing information thereon.

6. The system as defined in claim 5 wherein said information includes the weights of the livestock.

7. The system as defined in claim 5 further comprising a data collector for collecting a third set of data on said individual livestock upon delivery of said livestock to a retailer.

8. The system as defined in claim 7 wherein said processor is capable of tracking all data and reporting thereon.

9. The system as defined in claim 8 wherein a particular livestocks history is traceable and transparent.

10. A method for tracking livestock, the method comprising:
loading a group of livestock onto a plurality of successive conveyors;
separating individual livestock from said group by varying the speeds of the conveyors;
collecting a first set of data on the individual livestock;
loading the individual livestock into uniquely identifiable transport containers;
transporting the containers to a destination;
unloading the containers; and
collecting data on livestock and comparing the sets of data with respect to particular containers.

11. The method as defined in claim 10 further comprising:
collecting a third set of data upon delivery of the individual livestock to a retailer; and
processing all sets of data to track information on individual livestock.
